(19) United States
(12) Patent Application Publication
(10) Pub. No.: US 2026/0197688 A1
(43) Pub. Date: Jul. 9, 2026

(54) MEASUREMENT TIME PERIOD FOR ARTIFICIAL INTELLIGENCE/MACHINE LEARNING TECHNIQUES

(71) Applicant: QUALCOMM Incorporated, San Diego, CA (US)

(72) Inventors: Marwen ZORGUI, San Diego, CA (US); Roohollah AMIRI, San Diego, CA (US); Srinivas YERRAMALLI, San Diego, CA (US); Taesang YOO, San Diego, CA (US); Mohammed Ali Mohammed HIRZALLAH, San Marcos, CA (US); Alexandros MANOLAKOS, Athens (GR)

(21) Appl. No.: 18/868,663

(22) PCT Filed: Jun. 12, 2023
(86) PCT No.: PCT/US2023/025088

§ 371 Date: Nov. 22, 2024

(30) Foreign Application Priority Data
Jul. 13, 2022 (GR) 20220100556

(51) Int. Cl. H04W 24/10; H04L 41/16

(52) U.S. Cl. CPC H04W 24/10; H04L 41/16

(57) ABSTRACT

Aspects of the disclosure provide techniques for providing measurement time periods, such as measurement gaps and processing timelines, for artificial intelligence/machine learning (AI/ML) measurement operations and for joint legacy and AI/ML measurement operations. A UE can provide a network entity with a measurement capability of the UE indicating at least an AI/ML measurement capability. Based on the measurement capability of the UE, the network entity can provide a measurement configuration for the UE that includes a measurement time period for the UE to perform at least the AI/ML measurement operation.

### CROSS-REFERENCE TO RELATED APPLICATIONS

The present Application for Patent claims priority to Greece Application No. 20220100556, filed Jul. 13, 2022, and assigned to the assignee hereof and hereby expressly incorporated by reference herein as if fully set forth below and for all applicable purposes.

### TECHNICAL FIELD

The technology discussed below relates generally to wireless communication systems, and more particularly, to configuring measurement gaps or processing timelines for a user equipment (UE) to perform artificial intelligence/machine learning (AI/ML) measurement operations and/or joint legacy and AI/ML measurement operations.

### INTRODUCTION

In wireless communication systems, such as those specified under standards for 5G New Radio (NR), a network entity may provide a measurement configuration to a user equipment (UE) to enable the UE to perform measurement operations related to, for example, channel quality, beamforming, mobility, positioning, and other types of measurement operations. In some examples, the UE may further be provided with a measurement gap to allow the UE to perform inter-frequency or inter-radio access technology (RAT) measurements. A measurement gap may also be configured for a UE to perform intra-frequency measurements outside of the active bandwidth part (BWP) on which the UE is communicating with a serving cell. For measurement operations that are performed on subcarriers within the active BWP, such as channel state information (CSI) reporting and beam management operations, a measurement gap may not be needed. Therefore, instead of a measurement gap, the network entity may configure a processing timeline for the UE to perform the measurements simultaneously to transmitting/receiving on the serving cell.

Artificial intelligence (AI) can emulate human intelligence processes using machines, usually computer systems. Machine learning (ML) is a subset of AI that can create algorithms and statistical models to perform a specific task without using explicit instructions, relying instead on patterns and inference. In some wireless networks, replacing traditional wireless algorithms with AI and ML models may reduce power consumption and improve performance in wireless communication.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) including a transceiver configured for communication with a network entity, a memory, and a processor coupled to the transceiver and the memory is disclosed. The processor can be configured to transmit a measurement capability of the UE to the network entity via the transceiver. The measurement capability can indicate at least an artificial intelligence and machine learning (AI/ML) measurement capability of the UE. The processor can be further configured to receive a measurement configuration from the network entity via the transceiver. The measurement configuration can indicate a measurement time period within which the UE can perform at least an AI/ML measurement operation.

Another example provides a method for wireless communication at a user equipment (UE). The method includes transmitting a measurement capability of the UE to a network entity. The measurement capability indicating at least an artificial intelligence and machine learning (AI/ML) measurement capability of the UE. The method further includes receiving a measurement configuration from the network entity, the measurement configuration indicating a measurement time period within which the UE can perform at least an AI/ML measurement operation.

Another example provides a network entity including a memory and a processor coupled to the memory. The processor is configured to receive a measurement capability of a user equipment (UE). The measurement capability can indicate at least an artificial intelligence and machine learning (AI/ML) measurement capability of the UE. The processor is further configured to provide a measurement configuration for the UE. The measurement configuration can indicate a measurement time period within which the UE can perform at least an AI/ML measurement operation.

Another example provides a method for wireless communication at a network entity. The method includes receiving a measurement capability of a user equipment (UE). The measurement capability can indicate at least an artificial intelligence and machine learning (AI/ML) measurement capability of the UE. The method further includes providing a measurement configuration for the UE. The measurement configuration can indicate a measurement time period within which the UE can perform at least an AI/ML measurement operation.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system according to some aspects.

FIG. 2 is a diagram illustrating an example of a radio access network (RAN) according to some aspects.

FIG. 3 is a schematic illustration of an organization of wireless resources in an air interface utilizing orthogonal frequency divisional multiplexing (OFDM) according to some aspects.

FIG. 4 is a diagram providing a high-level illustration of one example of a configuration of a disaggregated base station according to some aspects.

FIG. 5 illustrates an example of a wireless communication system supporting beamforming between a network entity and a user equipment (UE) according to some aspects.

FIG. 6 is a signaling diagram illustrating exemplary signaling between a UE and a network entity for channel state information reporting according to some aspects.

FIG. 7 is a diagram illustrating an example of cell signal measurement according to some aspects.

FIG. 8 is a diagram illustrating an example of a measurement gap according to some aspects.

FIG. 9 is a diagram illustrating an example of an AI/ML measurement gap (MG) according to some aspects.

FIG. 10 is a signaling diagram illustrating exemplary signaling for configuring AI/ML measurement time periods according to some aspects.

FIG. 11 is a diagram illustrating an example of configuring an AI/ML measurement gap according to some aspects.

FIG. 12 is a diagram illustrating an example of a measurement configuration for joint legacy and AI/ML processing according to some aspects.

FIG. 13 is a signaling diagram illustrating exemplary signaling for a joint legacy and AI/ML measurement operation according to some aspects.

FIG. 14 is a block diagram illustrating an example of a hardware implementation for a user equipment employing a processing system according to some aspects.

FIG. 15 is a flow chart of an exemplary process for AI/ML measurement configuration according to some aspects.

FIG. 16 is a block diagram illustrating an example of a hardware implementation for a network entity employing a processing system according to some aspects.

FIG. 17 is a flow chart of another exemplary process for AI/ML measurement configuration according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure provide techniques for providing measurement time periods, such as measurement gaps and processing timelines, for artificial intelligence/machine learning (AI/ML) measurement operations and for joint legacy and AI/ML measurement operations. A user equipment (UE) can transmit a measurement capability of the UE to a network entity, such as an aggregated or disaggregated base station. The measurement capability can indicate at least an artificial intelligence/machine learning (AI/ML) measurement capability of the UE. In response and based on the UE measurement capability, the network entity can provide a measurement configuration for the UE. The measurement configuration can indicate a measurement time period within which the UE can perform at least an AI/ML measurement operation.

In some examples, the measurement capability includes a joint measurement capability indicating both the AI/ML measurement capability and a legacy non-AI/ML measurement capability of the UE. For example, the joint measurement capability may indicate that the UE supports a joint measurement operation including both the AI/ML measurement operation and a corresponding legacy non-AI/ML measurement operation. In this example, the joint measurement capability may further indicate whether the UE supports in parallel or sequential processing of the legacy and AI/ML measurement operations. In addition, the joint measurement capability may further indicate the measurement time period for performing the joint measurement operation.

In examples in which the measurement time period corresponds to a measurement gap, the measurement configuration may further include a measurement gap length of the measurement gap. In some examples, the measurement gap length may be one of a plurality of legacy non-AI/ML measurement gap lengths selected for the AI/ML measurement operation (or joint legacy-AI/ML measurement operation). In other examples, the measurement gap length may be a new measurement gap length configured for AI/ML measurement operations. In still other examples, the measurement gap length may be equal to a sum of an offset value and one of a plurality of legacy non-AI/ML measurement gap lengths.

In some examples, the measurement configuration may further include an order of priority of a legacy non-AI/ML measurement operation and an AI/ML measurement operation to be performed in the measurement time period. In this example, the measurement configuration may further include an opportunistic flag enabling the UE to opportunistically complete the AI/ML measurement operation and the legacy non-AI/ML measurement operation.

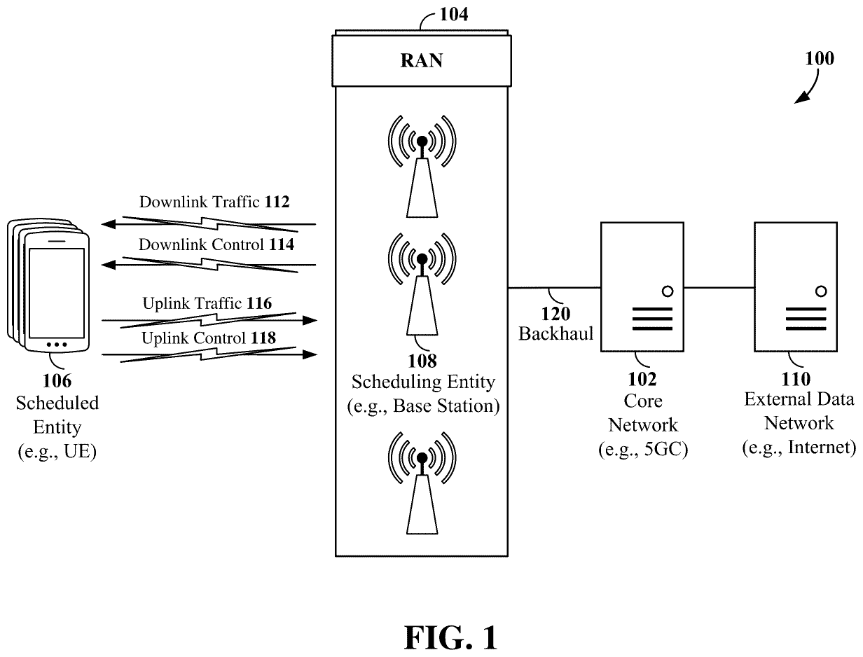

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

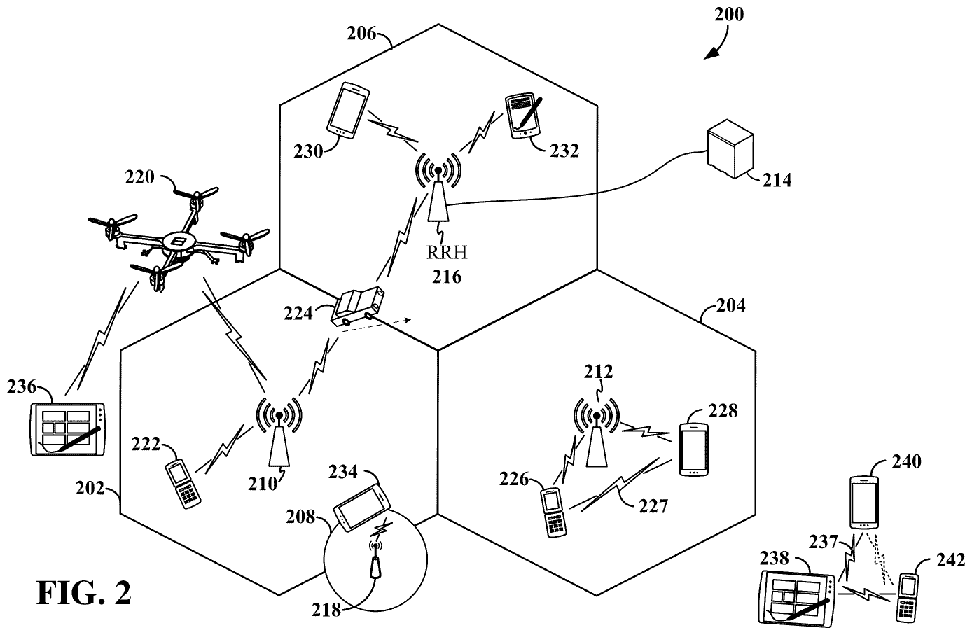

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

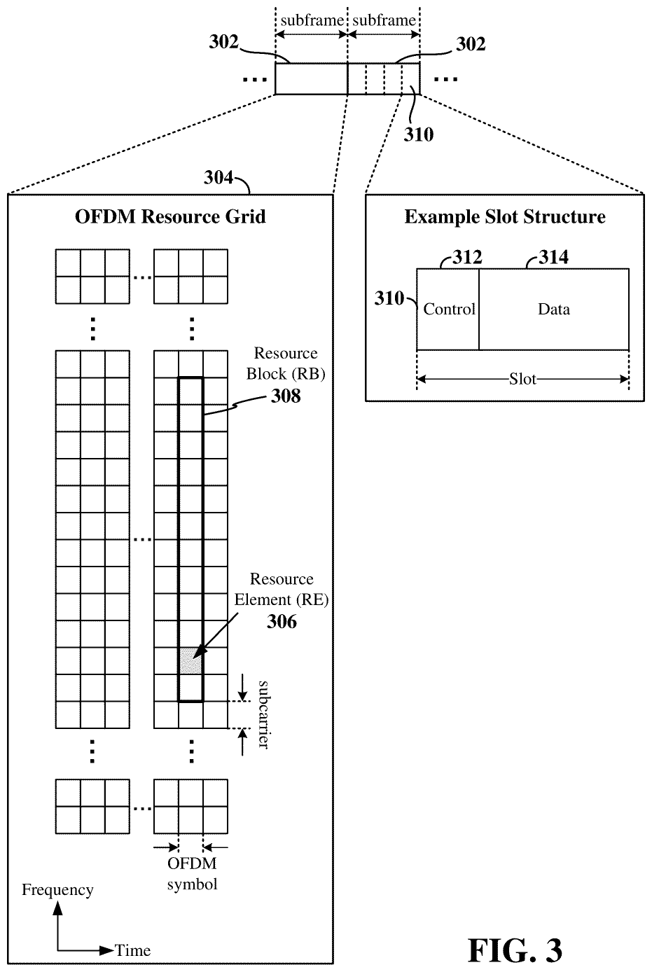

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgement (ACK) or negative acknowledgement (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

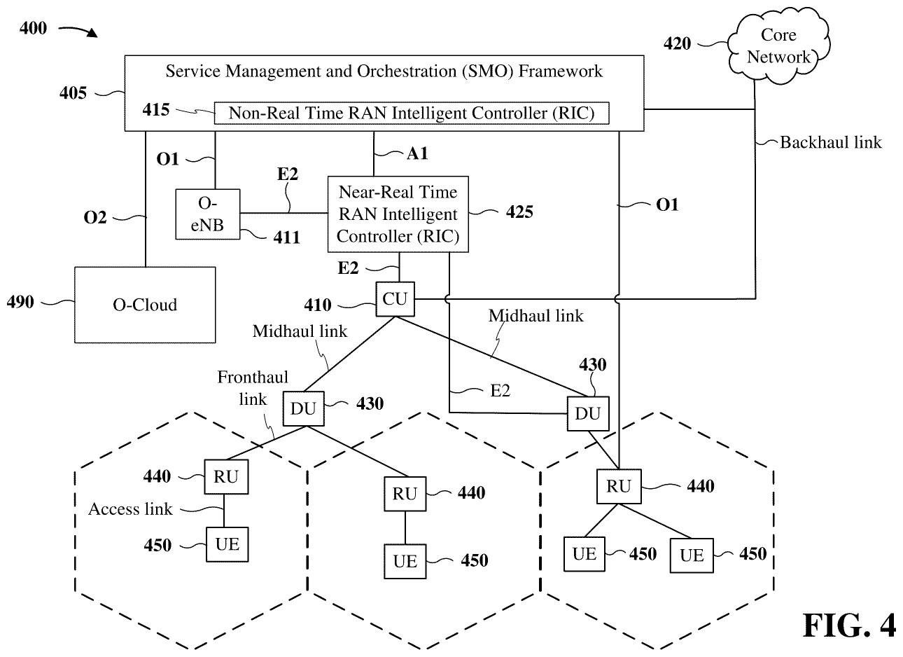

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

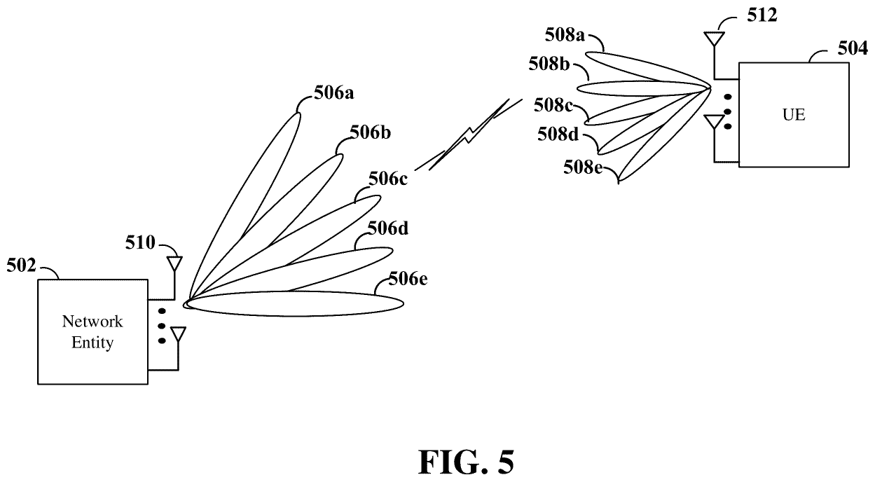

In some aspects of the disclosure, network entities and/or UEs may be configured for beamforming technology. FIG. 5 illustrates an example of a wireless communication system supporting beamforming between a network entity 502 and a UE 504. In a beamforming system, the network entity 502 includes multiple antennas 510. The use of such multiple antenna technology enables the wireless communication system to exploit the spatial domain to support spatial multiplexing, beamforming, and transmit diversity.

Beamforming is a signal processing technique that may be used at the network entity 502 and UE 504 to shape or steer an antenna beam (e.g., a transmit beam or receive beam) along a spatial path between the network entity 502 and the UE 504. Beamforming may be achieved by combining the signals communicated via antennas 510 (e.g., antenna elements of an antenna array or antenna panel) such that some of the signals experience constructive interference while others experience destructive interference. To create the desired constructive/destructive interference, the network entity 502 may apply amplitude and/or phase offsets to signals transmitted or received from each of the antennas 510. The UE 504 may further be configured with one or more beamforming antennas 512 (e.g., antenna panels) to transmit and/or receive beamformed signals to and/or from the network entity 502.

In the example shown in FIG. 5, the network entity 502 may be capable of generating one or more transmit/receive beams 506a-506e (e.g., network entity beams), each associated with a different spatial direction. In addition, the UE 504 may be configured to generate a plurality of transmit/receive beams 508a-508e (e.g., UE beams), each associated with a different spatial direction. It should be noted that while some beams are illustrated as adjacent to one another, such an arrangement may be different in different aspects. For example, the network entity 502 and UE 504 may each transmit more or less beams distributed in all directions (e.g., 350 degrees) and in three-dimensions.

The network entity 502 may generally be capable of communicating with the UE 504 using beams of varying beam widths. In some examples, to select a particular beam for communication with the UE 504, the network entity 502 may transmit a reference signal, such as a SSB or CSI-RS, on each of a plurality of beams (e.g., network entity beams 506a-506e) in a beam-sweeping manner. In some examples, SSBs may be transmitted on the wider beams, whereas CSI-RSs may be transmitted on the narrower beams. The UE 504 may measure the reference signal received power (RSRP) or signal-to-interference-plus-noise ratio (SINR) of each of the network entity beams 506a-506e on one or more of the UE beams 508a-508e and transmit a beam measurement report (e.g., a Layer 1 (L1) measurement report) to the network entity 502 indicating the RSRP or SINR of one or more of the measured network entity beams 506a-506e. The network entity 502 may then select the particular network entity beam (e.g., network entity beam 506c) for communication with the UE 504 based on the L1 measurement report. In some examples, the network entity 502 may further select a UE beam (e.g., UE beam 508d) for communication with the network entity 502, or the UE 504 may select the UE beam using a UE beam refinement procedure.

In addition, when the channel is reciprocal, the transmit/receive beams may be selected using an uplink beam management scheme. In an example, the UE 504 may be configured to sweep or transmit on each of a plurality of UE beams 508a-508e. For example, the UE 504 may transmit a sounding reference signal (SRS) on each beam in the different beam directions. In addition, the network entity 502 may be configured to receive the uplink beam reference signals on a plurality of network entity beams 506a-506h. The network entity 502 can then perform beam measurements (e.g., RSRP, SINR, etc.) of the beam reference signals on one or more of the network entity beams 506a-506h to determine the respective beam quality of each of the UE beams 508a-508e as measured on each of the one or more network entity beams 506a-506h.

In some examples, the network entity 502 may configure the UE 504 (e.g., via radio resource control (RRC) signaling) to perform SSB or CSI-RS beam measurements and provide an L1 measurement report containing the beam measurements. For example, the network entity 502 may provide a measurement configuration (e.g., RRC configuration) to the UE 504 that configures the UE 504 to perform SSB beam measurements and/or CSI-RS beam measurements for beam failure detection (BRD), beam failure recovery (BFR), cell reselection, beam tracking, or other beam optimization purpose.

In addition to L1 measurement reports, the UE 504 can further utilize the beam reference signals to estimate the channel quality of the channel between the network entity 502 and the UE 504. For example, the UE 504 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The scheduling entity may use the CSI report to select a rank for the UE 504, along with a precoding matrix and a MCS to use for future downlink transmissions to the UE 504. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

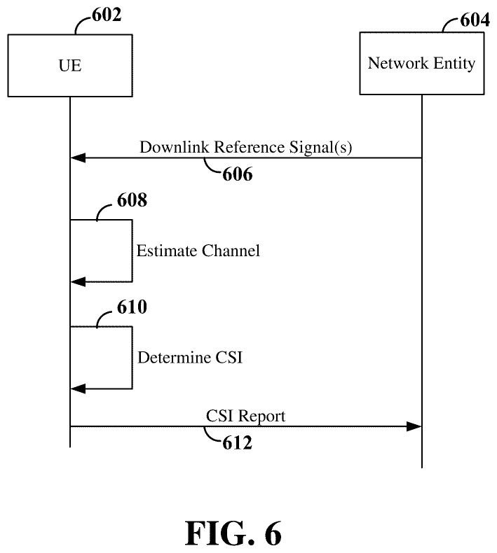

FIG. 6 is a signaling diagram illustrating exemplary signaling between a UE 602 and a network entity 604 for channel state information reporting according to some aspects. The UE 602 may correspond, for example, to any of the UEs or other scheduled entities shown in FIGS. 1, 2, and/or 5. The network entity 604 may correspond, for example, to any of the network entities (e.g., gNB or eNB) or other scheduling entities as shown in FIGS. 1, 2, 4, and/or 5.

At 606, the network entity 604 may transmit a downlink reference signal, such as a CSI-RS, to the UE 602. In some examples, the downlink reference signal may include a plurality of downlink reference signals. Each downlink reference signal may be transmitted via a respective CSI resource. CSI resources may include time-frequency resources, along with a beam direction (spatial direction), within which a particular downlink reference signal can be transmitted. In addition, each downlink reference signal may include a number of pilots allocated within the respective CSI resource. In some examples, the different spatial directions of the CSI resources may support MIMO (e.g., spatial multiplexing).

At 608, the UE 602 can estimate the downlink wireless channel from the downlink reference signal(s). For example, the UE 602 may measure the SINR of one or more of the downlink reference signals to obtain a downlink channel estimate of the downlink wireless channel.

At 610, for example, the UE 602 may determine the CSI. For example, the UE 602 may determine a RI, PMI, CQI, and LI from the downlink channel estimate. The CQI may include an index (e.g., a CQI index) ranging, for example, from 0 to 16. The CQI index may indicate, for example, the highest MCS at which the Block Error Rate (BLER) of the channel does not exceed 10%. Once selected, the RI, PMI, LI, and CQI index can be fed back in a CSI report. For example, at 612, the UE 602 may transmit the CSI report, including the selected CQI, along with the RI, PMI, and SLI, to the network entity 604.

In 5G NR, the network may configure measurements for purposes other than CSI reporting and beam management. For example, the network may configure the UE to perform reference signal measurements for radio resource management (RRM)/radio link monitoring (RLM), positioning, mobility (e.g., cell selection, cell reselection, handover, etc.), carrier aggregation, and other suitable purposes. For example, for RLM, the network may configure RLM-reference signal (RLM-RS) resources (e.g., SSB, CSI-RS, or a combination of SSB and CSI-RS) on which the UE can measure the downlink radio link quality of the camped cell on the camped active downlink BWP. The UE may compare the measured signal quality with one or more thresholds to determine the reliability of the downlink radio link quality.

For positioning, the network entity can configure positioning reference signal (PRS) resources in the downlink or SRS resources in the uplink (although other types of reference signals may also be used for positioning). In some examples, the PRS may be transmitted over multiple symbols that can be aggregated to accumulate power. In addition, the PRS may be transmitted in a beam-sweeping pattern. Based on PRSs received from the serving cell and neighbor cells, the UE may determine the reference signal time difference (RSTD), which corresponds to the measured time difference of arrival (TDOA) at the UE of PRSs received from a serving cell and neighbor cells. Using the RSTD and the known fixed positions of the TRPs within the cells, the position of the UE may be determined.

For mobility and/or carrier aggregation, the network can configure the UE to perform inter-RAT, inter-frequency (e.g., FR1 and FR2), and/or intra-frequency measurements (within different BWPs or the same BWP) on reference signals transmitted by the serving cell and neighboring cells. The UE can use the measurement configuration provided by the network to measure the signal quality or signal strength (e.g., RSRP or RSRQ) of the cells. For example, the UE can measure SSBs transmitted from the different cells.

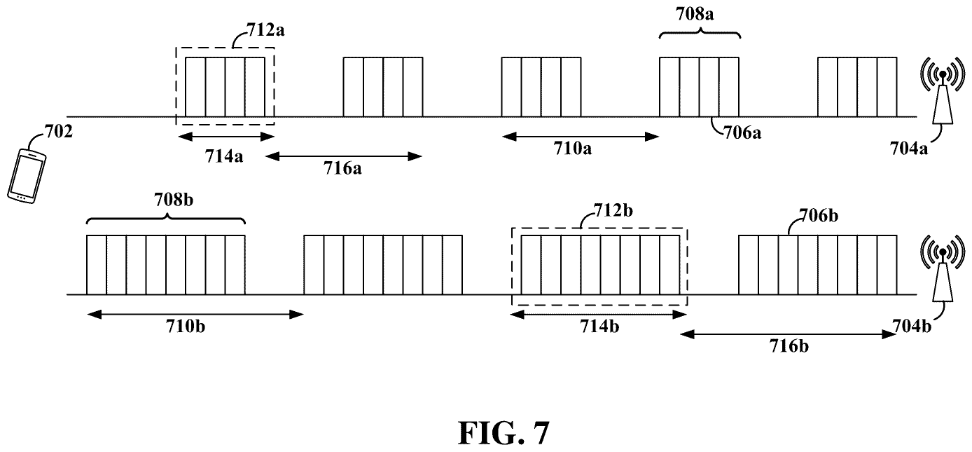

FIG. 7 is a diagram illustrating an example of cell signal measurement according to some aspects. In the example shown in FIG. 7, a UE 702 is configured to measure reference signals (e.g., SSBs) from cells (e.g., network entities) 704a and 704b. In some examples, one of the cells (e.g., cell 704a) is a serving cell. For example, each network entity 704a and 704b can broadcast a respective SSB burst 708a and 708b. Each SSB burst 708a and 708b includes a number of SSBs 706a and 706b transmitted on different beams (e.g., in different beam directions). In some examples, the number of SSBs 706a and 706b included in an SSB burst 708a and 708b may depend on the frequency range (e.g., FR1, FR2, etc) within which the SSBs are transmitted. For example, 4 SSBs may be used for FR1 below 3 GHz, 8 SSBs may be used for FR1 between 3 and 6 GHz, and 64 SSBs may be used for FR2. In the example shown in FIG. 7, the network entity 704a transmits an SSB burst 708a including four SSBs 706a, while network entity 704b transmits an SSB burst 708b including eight SSBs 706b.

Each network entity 704a and 704b may further transmit SSB bursts 708a and 708b with a respective SSB periodicity 710a and 710b. For example, the SSB periodicity 710a and 710b may be 5, 10, 20, 40, 80, or 160 ms. To facilitate transmission and measurement of the SSB bursts 708a and 708b, the network entities 704a and 704b and UE 702 may be configured (e.g., via a central network entity, such as a CU) with an SSB Measurement Time Configuration (SMTC) window and SSB Transmission Configuration (STC) window (e.g., windows 712a and 712b). The STC window indicates a period of time (e.g., one or more slots, subframes, or frames) within which the network entity 704a or 704b may transmit SSBs (e.g., SSB burst sets 708a and 708b including a plurality of SSBs 706a or 706b transmitted in a beam-sweeping manner). The SMTC window is aligned with the STC window to enable the UE 702 to measure the SSBs 706a and 706b transmitted from the network entities 704a and 704b.

Each SMTC/STC window 712a and 712b has a window duration 714a and 714b that can be set to 1, 2, 3, 4, or 5 ms, according to the number of SSBs 706a and 706b being transmitted within the corresponding SSB burst 708a and 708b. In addition, the SMTC/STC windows 712a and 712b each have a corresponding SMTC/STC periodicity 716a and 716b that is typically aligned to the periodicity (e.g., 20 ms) of SSB transmissions on the access link between the network entities 704a and 704b and the UE 702. However, a UE 702 in connected mode may not need to measure that often, particularly under good channel conditions. In such cases, the SMTC window periodicity can be longer than the SSB periodicity. The UE 702 may measure the SSBs 706a and 706b within the SMTC windows 712a and 712b and report the measurement results back to one or both of the network entities 704a and 704b.

The UE 702 may measure neighboring cells (e.g., network entity 704b) on the same frequency or within the same active BWP while simultaneously transmitting and receiving data from the serving cell (e.g., network entity 704a). In this example, the network (e.g., network entity 704a) may configure the UE 702 with a processing timeline for performing the measurements and reporting back to the network entity 704a.

However, to measure cells operating at different frequencies (e.g., inter-frequency neighbor cells), such as different BWPs of the same carrier frequency, different frequency ranges (e.g., FR1 and FR2), or different RATs (e.g., LTE and 5G NR), the UE 702 may suspend communication with the serving cell 704a and tune its RF module to the configured frequency of the neighbor cell 704b. The UE 702 may then resume communication with the serving cell 704a after completing the measurements.

To enable the UE 702 to suspend communication with the serving cell 704a, the network (e.g., network entity 704a) may configure the UE 702 with a measurement gap (MG). The MG can correspond to a time duration during which the UE 702 suspends communication with the serving cell 704a to measure neighbor cells 704b. Thus, no downlink or uplink transmissions to or from the UE 702 are scheduled during the MG. As used herein, the terms MG and processing timeline may collectively be referred to as a time measurement period. Both the MG and the processing timeline may be configured, for example, by RRC signaling. For example, the MG may be configured using a MeasGapConfig information element (IE) within a measurement configuration (e.g., a MeasConfig IE), which may be carried, for example, by an RRC Reconfiguration message.

A MG configuration includes the following parameters:
Measurement Gap Repetition Period: Specifies a MG gap period of 20, 40, 80, or 160 ms. For example, with a gap period of 40 ms, the gap repeats every four frames.
Gap Offset: Specifies the starting subframe of the MG based on the SMTC window periodicity. For example, if the periodicity is 20 ms, the Gap Offset ranges between 0 and 19.
Measurement Gap Length (MGL): Specifies the length of the MG. The MGL should be greater than the SMTC window duration (length). For example, MGLs can be 1.5, 3, 3.5, 4, 5.5, and 6 ms. For positioning measurements, MGLs of 10 and 20 ms are available.
Measurement Gap Timing Advance (MGTA): Specifies the time that the UE starts measurements in advance of the subframe when the MG starts. The amount of timing advance can be 0 or 0.25 ms for FR2 or 0, 0.25, or 0.5 ms for FR1.
Reference Serving Cell Indicator: Applicable for NE-DC (NR-E-UTRA dual connectivity) and NR-DC (NR dual connectivity). Specifies the cell's system frame number (SFN) and subframe numbering to use for MG calculation.

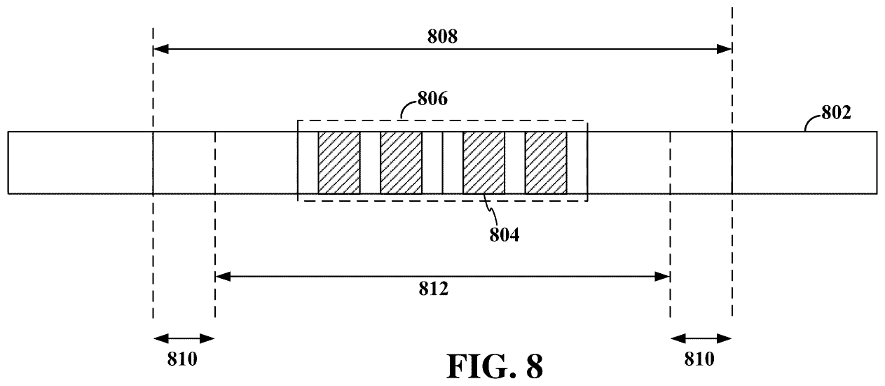

FIG. 8 is a diagram illustrating an example of a measurement gap (MG) according to some aspects. In 5G NR, the MGL is not fixed, but rather is configurable, as indicated above. As described above, the SMTC window and window duration may be set based the SSB duration (e.g., SSB burst set) and SSB periodicity. Similarly, in 5G NR, the MGL may also be set based on the SMTC window/SSB transmissions.

A MG (e.g., MG 808) can start during a subframe 802 that satisfies the Gap Offset and Measurement Gap Repetition Period (MGRP). In addition, the MG 808 can have a MGL configured based on the SMTC window duration. In the example shown in FIG. 8, an SMTC window 806 having an SMTC window duration of 2 ms (e.g., 2 subframes 802) is configured for an SSB burst including four SSBs 804. The MGL of the MG 808 can be set based on the STMC window duration. In general, as discussed above, the MGL should be greater than the SMTC window duration. Therefore, as shown in FIG. 8, the MG 808 can have a MGL of 4 ms (e.g., four subframes). At the beginning of the MG 808 and the end of the MG 808, an RF retuning period 810 (e.g., 0.5 ms) occurs to enable the UE to first retune to the carrier frequency of the neighbor cell to begin the measurement and then retune back to the carrier frequency of the serving cell after the measurement. Thus, in the example shown in FIG. 8, an actual measurement window 812 of 3 ms (e.g., 3 subframes 802) is configured.

In some aspects, artificial intelligence and machine learning (AI/ML) may be used in wireless communications, for example, operations of an air interface between a network and a UE. In some aspects, an AI/ML augmented air interface may have enhanced performance and/or reduced complexity and overhead. For example, the air interface (e.g., 5G NR) using AI/ML may have improved throughput, robustness, accuracy, reliability, etc. In one aspect, an AI/ML model can be used for CSI feedback enhancement, for example, overhead reduction, improved accuracy, and prediction. In one aspect, an AI/ML model can be used for beam management, for example, beam prediction in time and/or spatial domain, overhead and latency reduction, beam selection accuracy improvement, etc. In one aspect, an AI/ML model can be used for positioning accuracy enhancements in various scenarios including, for example, conditions with significant non-line-of-sight conditions.

The application of an AI/ML model in wireless communication, can involve various processes, for example, model training, model deployment, model inference, model monitoring, including model validation and model testing, model activation, model deactivation, and model switching. In some aspects, a UE and a network entity can have different levels of collaboration in different use cases of AI/ML models. In one aspect, no collaboration occurs between the UE and the network entity to use an AI/ML model. In this case, the UE and/or network entity can implement respective AI/ML models or algorithms without information exchange. In one aspect, signaling-based collaboration may be used without model transfer. For example, the UE can use signaling with a network entity to support training, inference, and/or verification of a predetermined AI/ML model without transferring or downloading the AI/ML model from the network. In one aspect, signaling-based collaboration may be used with AI/ML model transfer.

AI/ML model training is a process used to train an AI/ML model (e.g., by learning the input/output relationship of the model) in a data-driven manner and obtain the trained AI/ML model for inference. AI/ML model inference is a process of using a trained AI/ML model to produce a set of outputs based on a set of inputs. AI/ML validation is a process of evaluating the quality of an AI/ML model using a dataset different from the one used for model training. This process can help to select model parameters that generalize beyond the dataset used for model training.

AI/ML model testing is a process used to evaluate the performance of an applied AI/ML model using a dataset different from the one used for model training and validation. Different from the AI/ML model validation process, model testing may not perform subsequent tuning of the model. AI/ML model activation is a process used to enable an AI/ML model. AI/ML model deactivation is a process used to disable an AI/ML model. AI/ML model switching is a process used to deactivate a currently active AI/ML model and activate a different AI/ML model.

When a UE and a network entity collaborate to select an AI/ML model for wireless communication, the UE may perform various processes and collect data (e.g., measurements) as per the network entity's request. The collected data may be reported to the network entity. Before applying an AI/ML model (e.g., a model downloaded from a network entity or preconfigured), the UE may perform various processes, for example, measurements, model training and/or verification. For example, the UE and the network entity may check the performance of a newly updated/downloaded AI/ML model before applying the model to normal operations.

Measurement time periods, such as MGs and processing timelines, configured to enable a UE to perform measurement operations related to, for example, channel quality (e.g., CSI), beam management, mobility, carrier aggregation, positioning, and other types of measurement operations, were designed primarily for legacy (e.g., non AI/ML) measurement operations. However, for AI/ML-based measurement operations, the measurement time period configuration may need to be adjusted (e.g., extended) to allow for sufficient time to complete the AI/ML measurement operation. Furthermore, for AI/ML model monitoring, the network may configure the UE with both types of measurements (e.g., legacy, non-AI/ML and AI/ML-based measurements). Thus, the capabilities of the UE may need to support joint legacy and AI/ML processing.

Various aspects of the disclosure relate to techniques for providing measurement time periods (e.g., MGs and processing timelines) for AI/ML measurement operations and joint legacy and AI/ML measurement operations. In addition, various aspects of the disclosure introduce UE capabilities for AI/ML processing and joint legacy and AI/ML processing. Furthermore, various aspects of the disclosure provide measurement time periods for AI/ML model monitoring. By configuring a separate measurement time period for AI/ML measurement operations or joint legacy and AI/ML measurement operations based on a UE capability for performing AI/ML measurement operations or joint legacy and AI/ML measurement operations, the network can ensure that the UE is provided sufficient time to complete AI/ML or joint legacy and AI/ML measurement operations.

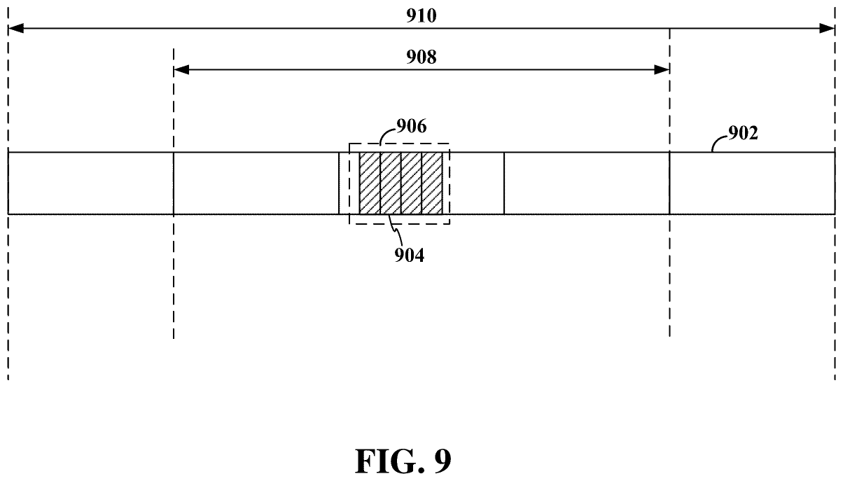

FIG. 9 is a diagram illustrating an example of an AI/ML measurement gap (MG) according to some aspects. Similar to the example shown in FIG. 8, in the example shown in FIG. 9, a legacy MG (e.g., MG 908) can start during a subframe 902 that satisfies the Gap Offset and Measurement Gap Repetition Period (MGRP). In addition, the legacy MG 908 can have a MGL configured based on the SMTC window duration. In the example shown in FIG. 9, an SMTC window 906 having an SMTC window duration of 2 ms (e.g., 2 subframes 902) is configured for an SSB burst including four SSBs 904. The MGL of the legacy MG 908 can be set based on the STMC window duration. For example, with an SMTC window 906 of 2 ms, the legacy MG 908 can have a MGL of 4 ms (e.g., four subframes).

In addition, an AI/ML MG 910 may be configured to extend the time for performing AI/ML measurement operations. For example, the AI/ML MG 910 may have an MGL of 6 ms (e.g., six subframes). In some examples, the AI/ML MG 910 may be based on a legacy MG. For example, the AI/ML MG 910 may have a MGL equal to the MGL of the legacy MG 908 plus an offset (e.g., 2 ms). As another example, the AI/ML MG 910 may correspond to a legacy MG configured for a different SMTC window (e.g., a longer SMTC window). In other examples, the AI/ML MG 910 may be a new type of MG specific for AI/ML measurements that considers the processing time of the AI/ML measurement operation. In some examples, the AI/ML MG 910 may be configured for a joint legacy and AI/ML measurement operation. In some examples, the network may configure the UE with both a legacy MG (e.g., legacy MG 908) and an AI/ML MG (e.g., AI/ML MG 910).

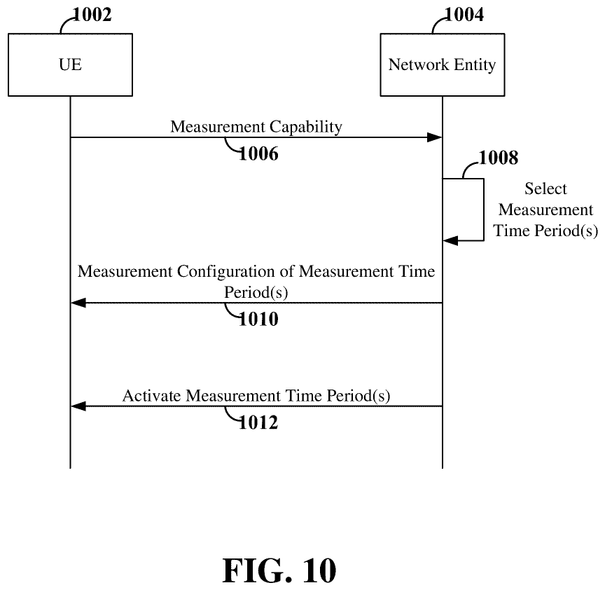

FIG. 10 is a diagram illustrating exemplary signaling between a UE 1002 and a network entity 1004 for configuring AI/ML measurement time periods according to some aspects. The UE 1002 may be any of the UEs or scheduled entities shown in FIGS. 1, 2, and/or 5-7. The network entity 1004 may be an aggregated or disaggregated network entity (e.g., may include one or more entities of a disaggregated base station) and may correspond, for example, to any of the network entities shown in FIGS. 1, 2, and/or 4-7.

At 1006, the UE 1002 can transmit a measurement capability (e.g., UE capability) of the UE to the network entity 1004. The measurement capability may indicate, for example, at least an AI/ML measurement capability of the UE. In some examples, the measurement capability may be a joint measurement capability indicating both the AI/ML measurement capability and a legacy (e.g., non-AI/ML) measurement capability. For example, for positioning measurement operations, a legacy measurement capability may include a capability of a UE to compute reference signal timing difference (RSTD) measurements, while an AI/ML measurement capability may include a capability of a UE to compute a full probability distribution of RSTD values.

In some examples, the joint measurement capability may indicate a respective measurement time period (e.g., MG/MGL or processing timeline) required by the UE to individually perform each of the legacy measurement operation and the AI/ML measurement operation. In some examples, the joint measurement capability further indicates whether the UE supports a joint measurement operation including both a legacy measurement operation and a corresponding AI/ML measurement operation. In this example, the joint measurement capability may further indicate whether the UE 1002 supports in parallel processing of the legacy and AI/ML measurement operations (e.g., performing the legacy and AI/ML measurement operations in parallel) and/or sequential processing of the legacy and AI/ML measurement operations (e.g., performing the legacy measurement operation prior to or subsequent to the AI/ML measurement operation). In this example, the joint measurement capability can further indicate the measurement time period(s) (e.g., MGs/MGLs or processing timelines) required by the UE 1002 for performing the joint measurement operation (e.g., in parallel and/or sequentially). In some examples, the joint measurement operation may correspond to an AI/ML model monitoring operation. In some examples, the measurement capability is specific to the AI/ML measurement operation or the joint measurement operation.

At 1008, the network entity 1004 can select one or more measurement time periods (e.g., MGs/MGLs and/or processing timelines) for the UE based on the measurement capability. For example, the network entity 1004 may select an AI/ML measurement time period, separate legacy and AI/ML measurement time periods, and/or a joint AI/ML measurement time period (e.g., for joint or sequential legacy and AI/ML measurement operations).

At 1010, the network entity 1004 can provide a measurement configuration of the measurement time period(s) for the UE 1002. For example, the measurement configuration can indicate a measurement time period within which the UE 1002 can perform at least an AI/ML measurement operation. In some examples, the measurement configuration may be an RRC configuration of one or more MGs and/or one or more processing timelines. In some examples, the measurement configuration is associated with only the AI/ML measurement operation. In other examples, the measurement configuration is associated with both the AI/ML measurement operation and a legacy (e.g., non-AI/ML) measurement operation. In this example, the measurement time period(s) can include a single measurement time period for jointly performing (e.g., in parallel or sequentially) the AI/ML measurement operation and the legacy measurement operation or separate measurement time periods for each of the AI/ML measurement operation and the legacy measurement operation.

In some examples, the measurement configuration may be associated with a AI/ML model monitoring operation including both the AI/ML measurement operation and a corresponding legacy (e.g., non-AI/ML) measurement operation. In this example, the measurement time period can be configured to enable the UE 1002 to jointly perform both the legacy measurement operation and the AI/ML measurement operation (e.g., in parallel or sequentially).

In some examples, the measurement configuration is associated with a joint measurement operation including the AI/ML measurement operation and a legacy (e.g., non-AI/ML) measurement operation to be performed by the UE 1002 during the measurement time period. In this example, the measurement configuration may further include an order of the AI/ML measurement operation and the legacy (e.g., non-AI/ML) measurement operation. In some examples, the measurement configuration may further include an opportunistic flag enabling the UE 1002 to opportunistically complete the AI/ML measurement operation and the legacy (e.g., non-AI/ML) measurement operation.

At 1012, the network entity 1004 can activate one or more of the measurement time periods. For example, the network entity 1004 may activate the measurement time period(s) via RRC signaling, a medium access control - control element (MAC-CE), or downlink control information (DCI). In examples in which the measurement time period includes separate legacy and AI/ML measurement time periods, the network entity 1004 may activate the legacy and AI/ML measurement time periods one at a time according to the operating mode of the UE 1002.

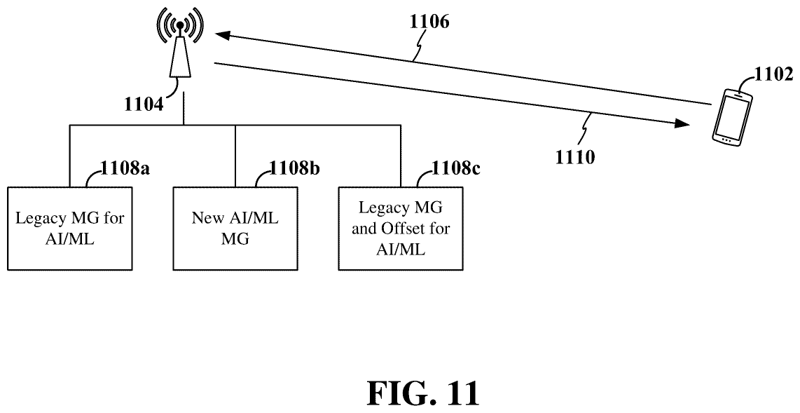

FIG. 11 is a diagram illustrating an example of communication between a UE 1102 and a network entity 1104 for configuring an AI/ML measurement gap according to some aspects. In the example shown in FIG. 11, the UE 1102 transmits a UE capability 1106 including a measurement capability of the UE 1102 to the network entity 1104. The measurement capability indicates at least an AI/ML measurement capability of the UE. Based on the measurement capability, the network entity 1104 can configure a measurement gap (MG) for the UE 1102. The network entity 1104 can then provide a measurement configuration 1110 indicating the MG and associated MGL configured for the UE 1102.

In some examples, as indicated by block 1108a, the network entity 1104 can configure a legacy MG for the UE 1102 including a MGL corresponding to one of a plurality of legacy (e.g., non-AI/ML) MGLs. Thus, the network entity 1104 can use the existing (legacy) MGs for AI/ML processing by configuring the MGL needed for performing the AI/ML measurement operation. For example, the network entity 1104 can select a longer legacy MGL for the UE 1102 to perform the AI/ML measurement operation than the traditional legacy MGL used for a corresponding legacy measurement operation to accommodate for the extra power and time needed for the UE 1102 to perform the AI/ML measurement operation.

In other examples, as indicated by block 1108b, the network entity 1104 can configure a new AI/ML MG for the UE 1102 including a MGL for the specific AI/ML measurement operation. In an example, the network entity 1104 can configure a plurality of new AI/ML MGs having MGLs different than a plurality of legacy (e.g., non-AI/ML) MGLs of legacy (e.g., non-AI/ML) MGs. The network entity 1104 can then configure (e.g., select) one of the AI/ML MGs for the UE 1102 to perform an AI/ML measurement operation based on the UE AI/ML measurement capability. In another example, the network entity 1104 can dynamically configure different AI/ML MGs for different UEs based on the AI/ML measurement capabilities of the UE.

In other examples, as indicated by block 1108c, the network entity 1104 can configure an AI/ML MG for the UE 1102 including a MGL equal to the sum of an offset value and one of a plurality of legacy (e.g., non-AI/ML) MGLs. For example, the network entity 1104 can select a legacy MG including a legacy MGL and add the offset value to the legacy MGL to produce the AI/ML MG including the AI/ML MGL. In this example, the offset value may be selected from a set of offset values that may be standardized. In other examples, the offset value may be UE-specific based on the UE capability (e.g., AI/ML measurement capability). For both blocks 1108b and 1108c, the network entity 1104 can further configure a legacy MG including a legacy MGL for the UE 1102 in addition to the AI/ML MG.

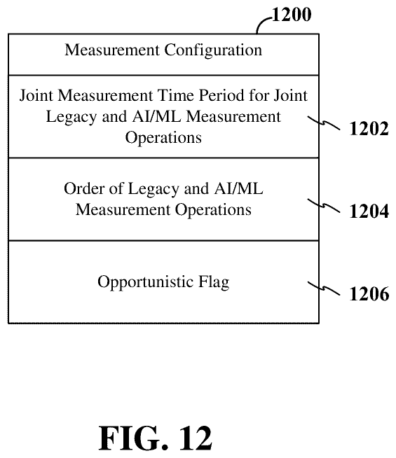

FIG. 12 is a diagram illustrating an example of a measurement configuration 1200 for joint legacy and AI/ML processing according to some aspects. In the example shown in FIG. 12, the measurement configuration 1200 (e.g., an RRC configuration) includes a joint measurement time period 1202 (e.g., a joint MG or joint processing timeline) for a UE to sequentially perform legacy (e.g., non-AI/ML) and AI/ML measurement operations. The measurement configuration 1200 further includes an order 1204 of the legacy measurement operation and the AI/ML measurement operation. For example, the order 1204 may indicate to perform the legacy operation prior to the AI/ML measurement operation or the AI/ML measurement operation prior to the legacy measurement operation.

The measurement configuration 1200 further includes an opportunistic flag 1206 enabling the UE to opportunistically complete the AI/ML measurement operation and the legacy measurement operation. For example, the opportunistic flag 1206 may enable the UE to opportunistically perform the AI/ML measurement operation and the legacy measurement operation in a different order than the order 1204 included in the measurement configuration 1200. As another example, the opportunistic flag 1206 may enable the UE to extend the measurement time period to complete the AI/ML measurement operation and the legacy measurement operation.

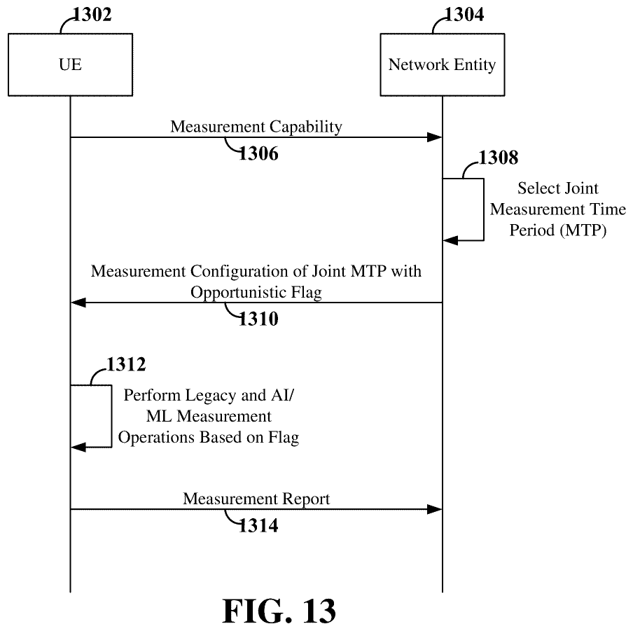

FIG. 13 is a signaling diagram illustrating exemplary signaling between a UE 1302 and a network entity 1304 for a joint legacy and AI/ML measurement operation according to some aspects. The UE 1302 may be any of the UEs or scheduled entities shown in FIGS. 1, 2, 5-7, 10, and/or 11. The network entity 1304 may be an aggregated or disaggregated network entity (e.g., may include one or more entities of a disaggregated base station) and may correspond, for example, to any of the network entities shown in FIGS. 1, 2, 4-7, 10, and/or 11.

At 1306, the UE 1302 can transmit a measurement capability (e.g., UE capability) of the UE to the network entity 1304. The measurement capability may indicate, for example, a joint measurement capability indicating both an AI/ML measurement capability and a legacy (e.g., non-AI/ML) measurement capability. For example, the joint measurement capability may indicate whether the UE supports a joint measurement operation including both a legacy measurement operation and a corresponding AI/ML measurement operation performed sequentially. In this example, the joint measurement capability can further indicate the measurement time period (e.g., MG/MGL or processing timeline) required by the UE 1302 for sequentially performing the joint measurement operation.

At 1308, the network entity 1304 can select a joint measurement time period (e.g., MG/MGL and/or processing timeline) for the UE based on the measurement capability. For example, the network entity 1304 may select a joint AI/ML measurement time period for sequential legacy and AI/ML measurement operations.

At 1310, the network entity 1304 can provide a measurement configuration (e.g., an RRC configuration) of the joint measurement time period for the UE 1302. For example, the measurement configuration can indicate a single measurement time period within which the UE 1302 can perform sequentially the AI/ML measurement operation and the legacy measurement operation. The measurement configuration may further include an opportunistic flag (e.g., the opportunistic flag may be enabled). In addition, the measurement configuration may further include an order of the AI/ML measurement operation and the legacy (e.g., non-AI/ML) measurement operation.

At 1312, the UE 1302 may perform the legacy and AI/ML measurement operations based on the opportunistic flag. For example, the UE 1302 may perform the legacy and AI/ML measurement operations in a different order than the order included in the measurement configuration. As another example, the UE 1302 may autonomously extend the measurement time period in order to complete both the legacy and AI/ML measurement operations. For example, if the UE 1302 has no data to process at the end of the measurement time period and the UE 1302 has not yet completed both the legacy and AI/ML measurement operations, the UE 1302 may extend the measurement time period based on the opportunistic flag.

At 1314, the UE 1302 may transmit a measurement report to the network entity 1304. The measurement report can contain both legacy measurement result(s) and an AI/ML measurement result(s) in the case in which the opportunistic approach (e.g., to perform out of order or to extend the measurement time period) was successful.

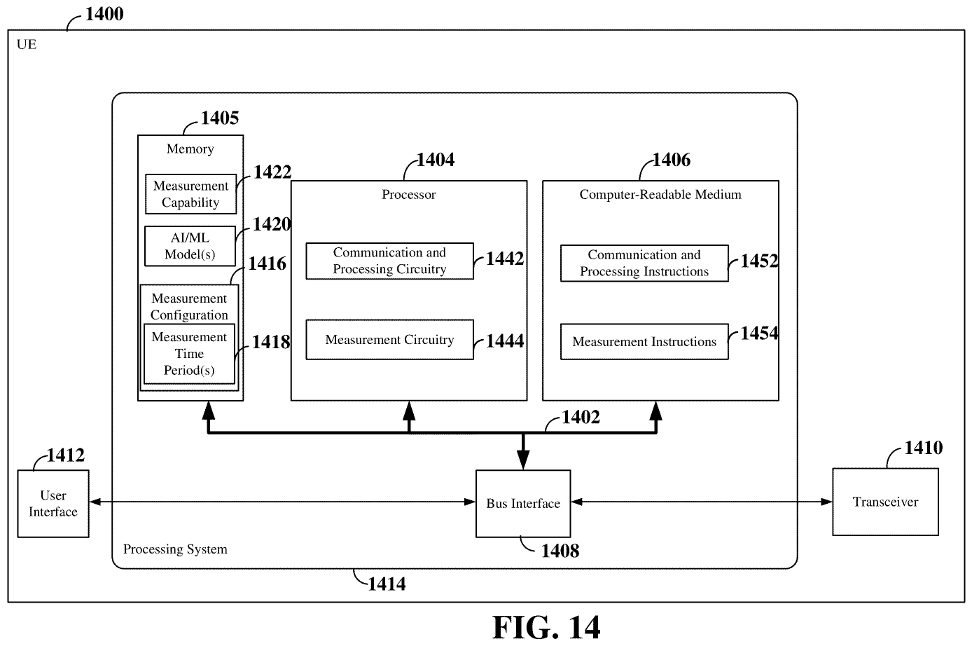

FIG. 14 is a block diagram illustrating an example of a hardware implementation of a user equipment (UE) 1400 employing a processing system 1414 according to some aspects. The UE 1400 may be any of the UEs or other scheduled entities illustrated in any one or more of FIGS. 1, 2, 5, 6, and/or 11-13.

In accordance with various aspects of the disclosure, an element, or any portion of an element, or any combination of elements may be implemented with a processing system 1414 that includes one or more processors, such as processor 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in the UE 1400, may be used to implement any one or more of the methods or processes described and illustrated, for example, in FIG. 6, 10, 11, 13 or 15.

The processor 1404 may in some instances be implemented via a baseband or modem chip and in other implementations, the processor 1404 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits, including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, are not described any further.

A bus interface 1408 provides an interface between the bus 1402 and a transceiver 1410. The transceiver 1410 may be, for example, a wireless transceiver. The transceiver 1410 provides a means for communicating with various other apparatus over a transmission medium (e.g., air interface). The transceiver 1410 may further be coupled to one or more antenna panels (not shown, for convenience) configured to generate one or more uplink transmit/downlink receive beams. The bus interface 1408 further provides an interface between the bus 1402 and a user interface 1412 (e.g., keypad, display, touch screen, speaker, microphone, control features, etc.). Of course, such a user interface 1412 may be omitted in some examples.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. In some examples, the computer-readable medium 1406 may be part of the memory 1405. Those skilled in the art will recognize how best to implement the described functionality presented throughout this disclosure depending on the particular application and the overall design constraints imposed on the overall system. In some examples, the computer-readable medium 1406 may be implemented on an article of manufacture, which may further include one or more other elements or circuits, such as the processor 1404 and/or memory 1405.

The computer-readable medium 1406 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1404, may be responsible for managing the bus 1402 and general processing, including the execution of the software (e.g., instructions or computer-executable code) stored on the computer-readable medium 1406. The software, when executed by the processor 1404, causes the processing system 1414 to perform the various processes and functions described herein for any particular apparatus. The computer-readable medium 1406 and/or the memory 1405 may also be used for storing data that may be manipulated by the processor 1404 when executing software. For example, the memory 1405 may store a measurement configuration 1416 including measurement time period(s) 1418, one or more AI/ML models 1420, and a measurement capability 1422 of the UE 1400.

In some aspects of the disclosure, the processor 1404 may include circuitry configured for various functions. For example, the processor 1404 may include communication and processing circuitry 1442 configured to communicate with a network entity (e.g., an aggregated or disaggregated base station, such as a gNB or eNB). In some examples, the communication and processing circuitry 1442 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1442 may include one or more transmit/receive chains.

In some implementations where the communication involves receiving information, the communication and processing circuitry 1442 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1442 may output the information to another component of the processor 1404, to the memory 1405, or to the bus interface 1408. In some examples, the communication and processing circuitry 1442 may receive one or more of signals, messages, other information, or any combination thereof. In some examples, the communication and processing circuitry 1442 may receive information via one or more channels. In some examples, the communication and processing circuitry 1442 may include functionality for a means for receiving. In some examples, the communication and processing circuitry 1442 may include functionality for a means for processing, including a means for demodulating, a means for decoding, etc.

In some implementations where the communication involves sending (e.g., transmitting) information, the communication and processing circuitry 1442 may obtain information (e.g., from another component of the processor 1404, the memory 1405, or the bus interface 1408), process (e.g., modulate, encode, etc.) the information, and output the processed information. For example, the communication and processing circuitry 1442 may output the information to the transceiver 1410 (e.g., that transmits the information via radio frequency signaling or some other type of signaling suitable for the applicable communication medium). In some examples, the communication and processing circuitry 1442 may send one or more of signals, messages, other information, or any combination thereof. In some examples, the communication and processing circuitry 1442 may send information via one or more channels. In some examples, the communication and processing circuitry 1442 may include functionality for a means for sending (e.g., a means for transmitting). In some examples, the communication and processing circuitry 1442 may include functionality for a means for generating, including a means for modulating, a means for encoding, etc.

In some examples, the communication and processing circuitry 1442 may be configured to transmit (e.g., via the transceiver 1410) a measurement capability (e.g., measurement capability 1422) of the UE to a network entity. The measurement capability 1422 can indicate at least an artificial intelligence and machine learning (AI/ML) measurement capability of the UE. In some examples, the measurement capability 1422 can include a joint measurement capability indicating the AI/ML measurement capability and a legacy non-AI/ML measurement capability. In some examples, the joint measurement capability further indicates whether the UE supports a joint measurement operation including the AI/ML measurement operation and a corresponding legacy non-AI/ML measurement operation. In this example, the joint measurement capability can further indicate whether the UE supports in parallel processing of the AI/ML measurement operation and the legacy non-AI/ML measurement operation or sequential processing of the AI/ML measurement operation and the legacy non-AI/ML measurement operation. In addition, the joint measurement capability can indicate a measurement time period (e.g., a requested MG or processing timeline) for performing the joint measurement operation in parallel or sequentially. In some examples, the measurement capability 1422 is specific to the AI/ML measurement operation or a joint measurement operation including the AI/ML measurement operation and a corresponding legacy non-AI/ML measurement operation.

The communication and processing circuitry 1442 may further be configured to receive (e.g., via the transceiver 1410) a measurement configuration (e.g., measurement configuration 1416) from the network entity. The measurement configuration 1416 can indicate a measurement time period 1418 within which the UE can perform at least an AI/ML measurement operation. In some examples, the measurement time period 1418 can include a measurement gap (MG) or a processing timeline. In some examples, the MG includes a measurement gap length (MGL) corresponding to one of a plurality of legacy non-AI/ML MGLs. In other examples, the MG includes an AI/ML MG having an AI/ML MGL selected from a plurality of AI/ML MGLs different than a plurality of legacy non-AI/ML MGLs. In this example, the measurement configuration 1416 may further include a legacy non-AI/ML MG within which the UE can perform a legacy non-AI/ML measurement operation. Here, the legacy non-AI/ML MG can have one of the plurality of legacy non-AI/ML MGLs. In other examples, the MG includes a MGL equal to a sum of an offset value and one of a plurality of legacy non-AI/ML MGLs. For example, the offset may be selected from a set of offset values or based on the measurement capability 1422 of the UE. In this example, the measurement configuration 1416 may further include a legacy non-AI/ML MG having a legacy non-AI/ML MGL within which the UE can perform a legacy non-AI/ML measurement operation.

In examples in which the measurement configuration 1416 is associated with an AI/ML model monitoring operation including both the AI/ML measurement operation and a corresponding legacy non-AI/ML measurement operation, the measurement time period 1418 may be configured to enable the UE to perform both the legacy non-AI/ML measurement operation and the AI/ML measurement operation. In examples in which the measurement configuration 1416 is associated with a joint measurement operation including the AI/ML measurement operation and a legacy non-AI/ML measurement operation to be performed by the UE during the measurement time period 1418, the measurement configuration 1416 may further include an order of the AI/ML measurement operation and the legacy non-AI/ML measurement operation and an opportunistic flag enabling the UE to opportunistically complete the AI/ML measurement operation and the legacy non-AI/ML measurement operation.

The communication and processing circuitry 1442 may further receive (e.g., via the transceiver 1410) one or more AI/ML models 1420 to be used by the UE 1400 to perform the AI/ML measurement operation. The communication and processing circuitry 1442 may further be configured to execute communication and processing instructions (software) 1452 stored on the computer-readable medium 1406 to implement one or more functions described herein.

The processor 1404 may further include measurement circuitry 1444 configured to perform one or more measurement operations related to, for example, channel quality (e.g., CSI), beam management, mobility, carrier aggregation, positioning, and other types of measurement operations, based on the measurement configuration 1416 and using, for example, the AI/ML model(s) 1420. In some examples, the measurement circuitry 1444 may be configured to perform an AI/ML measurement operation, separate AI/ML and legacy non-AI/ML measurement operations, or a joint measurement operation including both an AI/ML measurement operation and a corresponding legacy non-AI/ML measurement operation sequentially or in parallel based on the measurement configuration 1416 and associated measurement time period(s) 1418. For example, the measurement time period may be a new type of MG (e.g., an AI/ML MG) or a legacy MG with or without an offset configured for in parallel or sequential processing of legacy and AI/ML measurement operations.

For example, if the measurement configuration 1416 is associated with a joint measurement operation including in parallel legacy and AI/ML measurement operations, the measurement circuitry 1444 may be configured to perform both the legacy non-AI/ML measurement operation and AI/ML measurement operation in parallel during a single measurement time period 1418 allocated for both measurement operations. As another example, if the measurement configuration 1416 is associated with a joint measurement operation including in parallel legacy and AI/ML measurement operations, the measurement circuitry 1444 may be configured to perform both the legacy non-AI/ML measurement operation and AI/ML measurement operation sequentially during a single measurement time period 1418 allocated for both measurement operations. In this example, the measurement time period 1418 may be longer than for the in parallel measurement operations. In some examples, the joint measurement operation may be associated with an AI/ML model monitoring operation.

In examples in which the measurement configuration 1416 includes an order of priority (e.g., an order of performance) of the legacy and AI/ML measurement operations, along with an opportunistic flag, the measurement circuitry 1444 may further be configured to opportunistically perform the AI/ML measurement operation and the legacy non-AI/ML measurement operation in a different order than the order included within the measurement configuration 1416 based on the opportunistic flag. As another example, the measurement circuitry 1444 may be configured to opportunistically extend the measurement time period 1418 to complete the legacy non-AI/ML measurement operation and the AI/ML measurement operation based on the opportunistic flag. For example, if the UE has no data to process at the end of the measurement time period 1418 and the measurement circuitry 1444 has not yet completed both the legacy and AI/ML measurement operations, the measurement circuitry 1444 may extend the measurement time period based on the opportunistic flag. Thus, the measurement circuitry 1444 may be configured to perform the AI/ML measurement operation and the legacy non-AI/ML measurement operation based on the opportunistic flag.

In addition, the measurement circuitry 1444 may be configured to transmit a measurement report to the network entity. The measurement report may include measurement data obtained during the measurement operation(s). For example, the measurement report may include separate legacy and/or AI/ML measurement data or may include combined measurement data obtained from a combination of the legacy and AI/ML measurement operations. The measurement circuitry 1444 may further be configured to execute communication and processing instructions (software) 1454 stored on the computer-readable medium 1406 to implement one or more functions described herein.

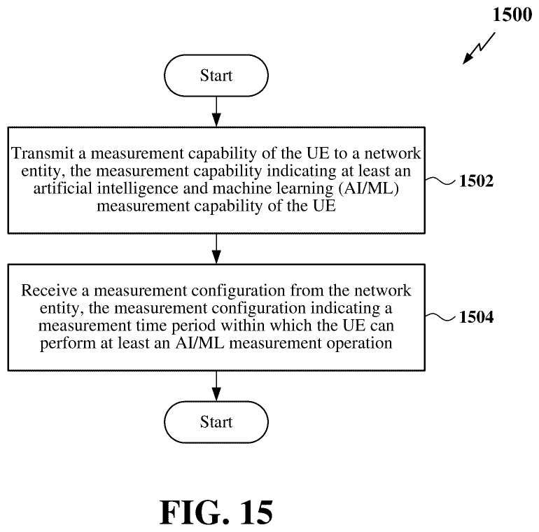

FIG. 15 is a flow chart illustrating an exemplary process 1500 AI/ML measurement configuration according to some aspects. As described below, some or all illustrated features may be omitted in a particular implementation within the scope of the present disclosure, and some illustrated features may not be required for implementation of all embodiments. In some examples, the process 1500 may be carried out by the UE 1400 illustrated in FIG. 14. In some examples, the process 1500 may be carried out by any suitable apparatus or means for carrying out the functions or algorithm described below.

At block 1502, the UE may transmit a measurement capability of the UE to a network entity. The measurement capability can indicate at least an artificial intelligence and machine learning (AI/ML) measurement capability of the UE. In some examples, the measurement capability includes a joint measurement capability indicating the AI/ML measurement capability and a legacy non-AI/ML measurement capability. In some examples, the joint measurement capability further indicates whether the UE supports a joint measurement operation including the AI/ML measurement operation and a corresponding legacy non-AI/ML measurement operation. Here, the joint measurement capability further indicates whether the UE supports in parallel processing of the AI/ML measurement operation and the legacy non-AI/ML measurement operation or sequential processing of the AI/ML measurement operation and the legacy non-AI/ML measurement operation.

In some examples, the joint measurement capability further indicates the measurement time period for performing the joint measurement operation in parallel or sequentially. In some examples, the measurement capability is specific to the AI/ML measurement operation or a joint measurement operation including the AI/ML measurement operation and a corresponding legacy non-AI/ML measurement operation. For example, the communication and processing circuitry 1442 together with the transceiver 1410 shown and described above in connection with FIG. 14 may provide a means to transmit the measurement capability to the network entity.

At block 1504, the UE may receive a measurement configuration from the network entity. The measurement configuration can indicate a measurement time period within which the UE can perform at least an AI/ML measurement operation. In some examples, the measurement time period includes a processing timeline. In other examples, the measurement time period includes a measurement gap. In some examples, the measurement gap includes a measurement gap length corresponding to one of a plurality of legacy non-AI/ML measurement gap lengths. In some examples, the measurement gap includes an AI/ML measurement gap having an AI/ML measurement gap length selected from a plurality of AI/ML measurement gap lengths different than a plurality of legacy non-AI/ML measurement gap lengths. In some examples, the measurement gap comprising a measurement gap length equal to a sum of an offset value and one of a plurality of legacy non-AI/ML measurement gap lengths. For example, the offset value can be selected from a set of offset values. As another example, the offset value can be based on the measurement capability of the UE. In addition, the measurement configuration can further include a legacy non-AI/ML measurement gap within which the UE can perform a legacy non-AI/ML measurement operation. Here, the legacy non-AI/ML measurement gap can have one of the plurality of legacy non-AI/ML measurement gap lengths.

In some examples, the measurement configuration is associated with an AI/ML model monitoring operation including both the AI/ML measurement operation and a corresponding legacy non-AI/ML measurement operation, and the measurement time period is configured to enable the UE to perform both the legacy non-AI/ML measurement operation and the AI/ML measurement operation. In some examples, the measurement configuration is associated with a joint measurement operation including the AI/ML measurement operation and a legacy non-AI/ML measurement operation to be performed by the UE during the measurement time period. In this example, the measurement configuration can further include an order of the AI/ML measurement operation and the legacy non-AI/ML measurement operation and an opportunistic flag enabling the UE to opportunistically complete the AI/ML measurement operation and the legacy non-AI/ML measurement operation. For example, the opportunistic flag can enable the UE to opportunistically perform the AI/ML measurement operation and the legacy non-AI/ML measurement operation in a different order than the order included in the measurement configuration. As another example, the opportunistic flag can enable the UE to opportunistically extend the measurement time period to complete the AI/ML measurement operation and the legacy non-AI/ML measurement operation.

In some examples, the UE may further perform the AI/ML measurement operation and the legacy non-AI/ML measurement operation based on the opportunistic flag and transmit a measurement report to the network entity. For example, the communication and processing circuitry 1442, together with the measurement circuitry 1444 and transceiver 1410, shown and described above in connection with FIG. 14 may provide a means to receive the first reference signal.

In one configuration, the UE includes means for transmitting a measurement capability of the UE to a network entity, the measurement capability indicating at least an artificial intelligence and machine learning (AI/ML) measurement capability of the UE, and means for receiving a measurement configuration from the network entity, the measurement configuration indicating a measurement time period within which the UE can perform at least an AI/ML measurement operation. In one aspect, the aforementioned means may be the processor 1404 shown in FIG. 14 configured to perform the functions recited by the aforementioned means. In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable storage medium 1406, or any other suitable apparatus or means described in any one of the FIGS. 1, 2, 5, 6, 10, 11, 13, and 14, and utilizing, for example, the processes and/or algorithms described herein in relation to FIGS. 6, 10, 11, 13, and 15.

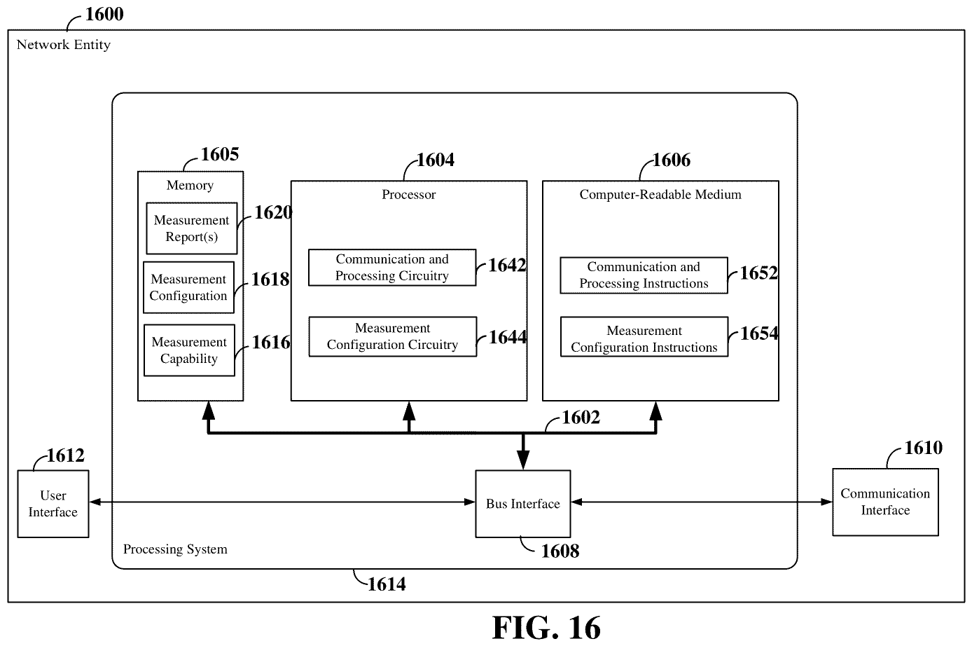

FIG. 16 is a block diagram illustrating an example of a hardware implementation of a network entity 1600 employing a processing system 1614 according to some aspects. The network entity 1600 may be, for example, any base station (e.g., gNB, eNB) or other scheduling entity as illustrated in any one or more of FIGS. 1, 2, 5, 6, 10, 11, and/or 13. The network entity 1600 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, the network entity 1600 may be a stationary network entity or a mobile network entity.

In accordance with various aspects of the disclosure, an element, or any portion of an element, or any combination of elements may be implemented with a processing system 1614 that includes one or more processors, such as processor 1604. The processing system 1614 may be substantially the same as the processing system 1414 as shown and described above in connection with FIG. 14, including a bus interface 1608, a bus 1602, a memory 1605, a processor 1604, and a computer-readable medium 1606. Accordingly, their descriptions will not be repeated for the sake of brevity. Furthermore, the network entity 1600 may include an optional user interface 1612 and a communication interface 1610. The communication interface 1610 may provide an interface (e.g., wireless or wired) between the network entity 1600 and a plurality of transmission and reception points (TRPs), a core network node, and/or a plurality of UEs. In some examples, the communication interface 1610 may include a wireless transceiver.

The processor 1604, as utilized in the network entity 1600, may be used to implement any one or more of the processes described below. In some examples, the memory 1605 may store a measurement capability 1616 of a UE, a measurement configuration 1618 generated for the UE based on the measurement capability 1616, and one or more measurement report(s) 1620 received from the UE based on the measurement configuration 1618.

In some aspects of the disclosure, the processor 1604 may include communication and processing circuitry 1642 configured for various functions, including, for example, communicating with one or more UEs or other scheduled entities, or a core network node. In some examples, the communication and processing circuitry 1642 may communicate with one or more UEs via one or more TRPs associated with the network entity 1600. In some examples, the communication and processing circuitry 1642 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1642 may be configured to process and transmit downlink traffic and downlink control and receive and process uplink traffic and uplink control.

In some examples, the communication and processing circuitry 1642 may be configured to receive a measurement capability (e.g., measurement capability 1616) of a user equipment (UE). The measurement capability 1616 can indicate at least an artificial intelligence and machine learning (AI/ML) measurement capability of the UE. In some examples, the measurement capability 1616 includes a joint measurement capability indicating the AI/ML measurement capability and a legacy non-AI/ML measurement capability. In some examples, the joint measurement capability further includes whether the UE supports a joint measurement operation including the AI/ML measurement operation and a corresponding legacy non-AI/ML measurement operation. In this example, the joint measurement capability can further indicate whether the UE supports in parallel processing of the AI/ML measurement operation and the legacy non-AI/ML measurement operation or sequential processing of the AI/ML measurement operation and the legacy non-AI/ML measurement operation. In this example, the joint measurement capability can further indicate a measurement time period (e.g., MG or processing timeline) for performing the joint measurement operation in parallel or sequentially. In some examples, the measurement capability 1616 is specific to the AI/ML measurement operation or a joint measurement operation including the AI/ML measurement operation and a corresponding legacy non-AI/ML measurement operation.

The communication and processing circuitry 1642 may further be configured to provide a measurement configuration 1618 for the UE. The measurement configuration can indicate a measurement time period within which the UE can perform at least an AI/ML measurement operation. In some examples, the measurement time period includes a measurement gap. In other examples, the measurement time period includes a processing timeline.

The communication and processing circuitry 1642 may further be configured to receive a measurement report (e.g., measurement report 1620) from the UE based on the measurement configuration 1618. The communication and processing circuitry 1642 may further be configured to execute communication and processing instructions (software) 1652 stored on the computer-readable medium 1606 to implement one or more functions described herein.

The processor 1604 may further include measurement configuration circuitry 1644 configured to generate the measurement configuration 1618 for the UE based on the measurement capability 1616 of the UE. In some examples, the measurement configuration circuitry 1644 may be configured to generate the measurement configuration 1618 including a measurement gap (MG). For example, the MG can include a measurement gap length (MGL) corresponding to one of a plurality of legacy non-AI/ML MGLs. As another example, the MG can include an AI/ML MG having an AI/ML MGL selected from a plurality of AI/ML MGLs different than a plurality of legacy non-AI/ML MGLs. In this example, the measurement configuration 1618 can further include a legacy non-AI/ML MG within which the UE can perform a legacy non-AI/ML measurement operation. Here, the legacy non-AI/ML MG has one of the plurality of legacy non-AI/ML MLGs. As another example, the MG can include a MGL equal to a sum of an offset value and one of a plurality of legacy non-AI/ML MGLs. For example, the offset value may be selected from a set of offset values maintained by the network entity 1600 or may be based on the measurement capability 1616 of the UE. In this example, the measurement configuration 1618 can further include a legacy non-AI/ML MG having one of the plurality of legacy non-AI/ML MGLs within which the UE can perform a legacy non-AI/ML measurement operation.

In some examples, the measurement configuration 1618 produced by the measurement configuration circuitry 1644 may be associated with an AI/ML model monitoring operation including both the AI/ML measurement operation and a corresponding legacy non-AI/ML measurement operation. In this example, the measurement time period can be configured to enable the UE to perform both the legacy non-AI/ML measurement operation and the AI/ML measurement operation. In some examples, the measurement configuration 1618 produced by the measurement configuration circuitry 1644 is associated with a joint measurement operation including the AI/ML measurement operation and a legacy non-AI/ML measurement operation to be performed by the UE during the measurement time period. In this example, the measurement configuration 1618 produced by the measurement configuration circuitry 1644 can further include an order of the AI/ML measurement operation and the legacy non-AI/ML measurement operation and an opportunistic flag enabling the UE to opportunistically complete the AI/ML measurement operation and the legacy non-AI/ML measurement operation. The measurement configuration circuitry 1644 may further be configured to execute measurement configuration instructions (software) 1654 stored on the computer-readable medium 1606 to implement one or more functions described herein.

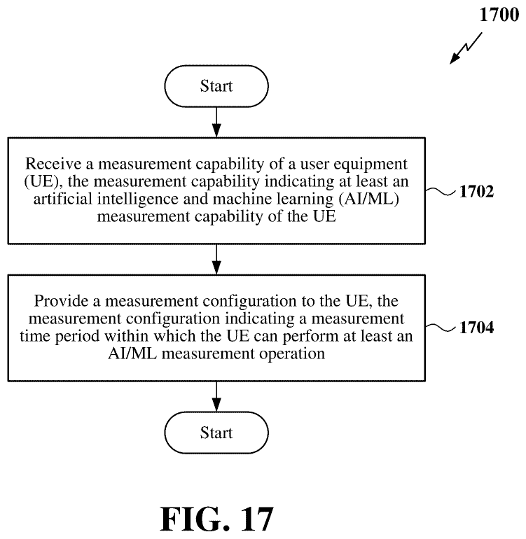

FIG. 17 is a flow chart illustrating another exemplary process 1700 for AI/ML measurement configuration according to some aspects. As described below, some or all illustrated features may be omitted in a particular implementation within the scope of the present disclosure, and some illustrated features may not be required for implementation of all embodiments. In some examples, the process 1700 may be carried out by the network entity 1600 illustrated in FIG. 16. In some examples, the process 1700 may be carried out by any suitable apparatus or means for carrying out the functions or algorithm described below.

At block 1702, the network entity may receive a measurement capability of a user equipment (UE). The measurement capability can indicate at least an artificial intelligence and machine learning (AI/ML) measurement capability of the UE. In some examples, the measurement capability includes a joint measurement capability indicating the AI/ML measurement capability and a legacy non-AI/ML measurement capability. In some examples, the joint measurement capability further indicates whether the UE supports a joint measurement operation including the AI/ML measurement operation and a corresponding legacy non-AI/ML measurement operation. The joint measurement capability can further indicate whether the UE supports in parallel processing of the AI/ML measurement operation and the legacy non-AI/ML measurement operation or sequential processing of the AI/ML measurement operation and the legacy non-AI/ML measurement operation. In some examples, the joint measurement capability further indicates the measurement time period for performing the joint measurement operation in parallel or sequentially. In some examples, the measurement capability is specific to the AI/ML measurement operation or a joint measurement operation including the AI/ML measurement operation and a corresponding legacy non-AI/ML measurement operation. For example, the communication and processing circuitry 1642, together with the communication interface 1610, shown and described above in connection with FIG. 16 may provide a means to receive the measurement capability.

At block 1704, the network entity may provide a measurement configuration for the UE. The measurement configuration can indicate a measurement time period within which the UE can perform at least an AI/ML measurement operation. In some examples, the measurement time period includes a processing timeline. In other examples, the measurement time period includes a measurement gap. In some examples, the measurement gap includes a measurement gap length corresponding to one of a plurality of legacy non-AI/ML measurement gap lengths. In other examples, the measurement gap includes an AI/ML measurement gap having an AI/ML measurement gap length selected from a plurality of AI/ML measurement gap lengths different than a plurality of legacy non-AI/ML measurement gap lengths. In some examples, the measurement gap includes a measurement gap length equal to a sum of an offset value and one of a plurality of legacy non-AI/ML measurement gap lengths. For example, the offset value may be selected from a set of offset values or may be based on the measurement capability of the UE.

In some examples, the measurement configuration is associated with an AI/ML model monitoring operation including both the AI/ML measurement operation and a corresponding legacy non-AI/ML measurement operation, and the measurement time period is configured to enable the UE to perform both the legacy non-AI/ML measurement operation and the AI/ML measurement operation. In some examples, the measurement configuration is associated with a joint measurement operation including the AI/ML measurement operation and a legacy non-AI/ML measurement operation to be performed by the UE during the measurement time period. In this example, the measurement configuration further includes an order of the AI/ML measurement operation and the legacy non-AI/ML measurement operation and an opportunistic flag enabling the UE to opportunistically complete the AI/ML measurement operation and the legacy non-AI/ML measurement operation. For example, the communication and processing circuitry 1642, together with the measurement configuration circuitry 1644 and communication interface 1610, shown and described above in connection with FIG. 16 may provide a means to provide the measurement configuration.

In one configuration, the network entity includes means for receiving a measurement capability of a user equipment (UE), the measurement capability indicating at least an artificial intelligence and machine learning (AI/ML) measurement capability of the UE and means for providing a measurement configuration for the UE, the measurement configuration indicating a measurement time period within which the UE can perform at least an AI/ML measurement operation. In one aspect, the aforementioned means may be the processor 1604 shown in FIG. 16 configured to perform the functions recited by the aforementioned means. In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable storage medium 1606, or any other suitable apparatus or means described in any one of FIGS. 1, 2, 6, 10, 11, 13, and 16, and utilizing, for example, the processes and/or algorithms described herein in relation to FIGS. 6, 10, 11, 13, and 17.

The following provides an overview of aspects of the present disclosure:
Aspect 1: A method for wireless communication at a user equipment (UE), the method comprising: transmitting a measurement capability of the UE to a network entity, the measurement capability indicating at least an artificial intelligence and machine learning (AI/ML) measurement capability of the UE; and receiving a measurement configuration from the network entity, the measurement configuration indicating a measurement time period within which the UE can perform at least an AI/ML measurement operation.
Aspect 2: The method of aspect 1, wherein the measurement capability comprises a joint measurement capability indicating the AI/ML measurement capability and a legacy non-AI/ML measurement capability.
Aspect 3: The method of aspect 2, wherein the joint measurement capability further indicates whether the UE supports a joint measurement operation including the AI/ML measurement operation and a corresponding legacy non-AI/ML measurement operation, the joint measurement capability further indicating whether the UE supports in parallel processing of the AI/ML measurement operation and the legacy non-AI/ML measurement operation or sequential processing of the AI/ML measurement operation and the legacy non-AI/ML measurement operation.
Aspect 4: The method of aspect 3, wherein the joint measurement capability further indicates the measurement time period for performing the joint measurement operation in parallel or sequentially.
Aspect 5: The method of any of aspects 1 through 4, wherein the measurement capability is specific to the AI/ML measurement operation or a joint measurement operation including the AI/ML measurement operation and a corresponding legacy non-AI/ML measurement operation.
Aspect 6: The method of any of aspects 1 through 5, wherein the measurement time period comprises a measurement gap.
Aspect 7: The method of aspect 6, wherein the measurement gap comprises a measurement gap length corresponding to one of a plurality of legacy non-AI/ML measurement gap lengths.
Aspect 8: The method of aspect 6, wherein the measurement gap comprises an AI/ML measurement gap having an AI/ML measurement gap length selected from a plurality of AI/ML measurement gap lengths different than a plurality of legacy non-AI/ML measurement gap lengths.
Aspect 9: The method of aspect 8, wherein the measurement configuration further comprises a legacy non-AI/ML measurement gap within which the UE can perform a legacy non-AI/ML measurement operation, the legacy non-AI/ML measurement gap having one of the plurality of legacy non-AI/ML measurement gap lengths.
Aspect 10: The method of aspect 6, wherein the measurement gap comprising a measurement gap length equal to a sum of an offset value and one of a plurality of legacy non-AI/ML measurement gap lengths.
Aspect 11: The method of aspect 10, wherein the offset value is selected from a set of offset values.
Aspect 12: The method of aspect 10, wherein the offset value is based on the measurement capability of the UE.
Aspect 13: The method of any of aspects 10 through 12, wherein the measurement configuration further comprises a legacy non-AI/ML measurement gap within which the UE can perform a legacy non-AI/ML measurement operation, the legacy non-AI/ML measurement gap having one of the plurality of legacy non-AI/ML measurement gap lengths.
Aspect 14: The method of any of aspects 1 through 13, wherein the measurement configuration is associated with an AI/ML model monitoring operation including both the AI/ML measurement operation and a corresponding legacy non-AI/ML measurement operation, and the measurement time period is configured to enable the UE to perform both the legacy non-AI/ML measurement operation and the AI/ML measurement operation.
Aspect 15: The method of any of aspects 1 through 14, wherein the measurement configuration is associated with a joint measurement operation including the AI/ML measurement operation and a legacy non-AI/ML measurement operation to be performed by the UE during the measurement time period, the measurement configuration further comprises an order of the AI/ML measurement operation and the legacy non-AI/ML measurement operation and an opportunistic flag enabling the UE to opportunistically complete the AI/ML measurement operation and the legacy non-AI/ML measurement operation.
Aspect 16: The method of aspect 15, wherein the opportunistic flag enables the UE to opportunistically perform the AI/ML measurement operation and the legacy non-AI/ML measurement operation in a different order than the order included within the measurement configuration.
Aspect 17: The method of aspect 15 or 16, wherein the opportunistic flag enables the UE to opportunistically extend the measurement time period to complete the AI/ML measurement operation and the legacy non-AI/ML measurement operation.
Aspect 18: The method of any of aspects 15 through 17, further comprising: performing the AI/ML measurement operation and the legacy non-AI/ML measurement operation based on the opportunistic flag; and transmitting a measurement report to the network entity.
Aspect 19: The method of any of aspects 1 through 5 or 14 through 18, wherein the measurement time period comprises a processing timeline.
Aspect 20: A method for wireless communication at a network entity, comprising: receiving a measurement capability of a user equipment (UE), the measurement capability indicating at least an artificial intelligence and machine learning (AI/ML) measurement capability of the UE; and providing a measurement configuration for the UE, the measurement configuration indicating a measurement time period within which the UE can perform at least an AI/ML measurement operation.
Aspect 21: The method of aspect 20, wherein the measurement capability comprises a joint measurement capability indicating the AI/ML measurement capability and a legacy non-AI/ML measurement capability.
Aspect 22: The method of aspect 21, wherein the joint measurement capability further indicates whether the UE supports a joint measurement operation including the AI/ML measurement operation and a corresponding legacy non-AI/ML measurement operation, the joint measurement capability further indicating whether the UE supports in parallel processing of the AI/ML measurement operation and the legacy non-AI/ML measurement operation or sequential processing of the AI/ML measurement operation and the legacy non-AI/ML measurement operation.
Aspect 23: The method of aspect 22, wherein the joint measurement capability further indicates the measurement time period for performing the joint measurement operation in parallel or sequentially.
Aspect 24: The method of any of aspects 20 through 23, wherein the measurement capability is specific to the AI/ML measurement operation or a joint measurement operation including the AI/ML measurement operation and a corresponding legacy non-AI/ML measurement operation.
Aspect 25: The method of any of aspects 20 through 24, wherein the measurement time period comprises a measurement gap.
Aspect 26: The method of aspect 25, wherein the measurement gap comprises a measurement gap length corresponding to one of a plurality of legacy non-AI/ML measurement gap lengths.
Aspect 27: The method of aspect 25, wherein the measurement gap comprises an AI/ML measurement gap having an AI/ML measurement gap length selected from a plurality of AI/ML measurement gap lengths different than a plurality of legacy non-AI/ML measurement gap lengths.
Aspect 28: The method of aspect 25, wherein the measurement gap comprising a measurement gap length equal to a sum of an offset value and one of a plurality of legacy non-AI/ML measurement gap lengths.
Aspect 29: The method of aspect 28, wherein the offset value is selected from a set of offset values.
Aspect 30: The method of aspect 28, wherein the offset value is based on the measurement capability of the UE.
Aspect 31: The method of any of aspects 20 through 30, wherein the measurement configuration is associated with an AI/ML model monitoring operation including both the AI/ML measurement operation and a corresponding legacy non-AI/ML measurement operation, and the measurement time period is configured to enable the UE to perform both the legacy non-AI/ML measurement operation and the AI/ML measurement operation.
Aspect 32: The method of any of aspects 20 through 31, wherein the measurement configuration is associated with a joint measurement operation including the AI/ML measurement operation and a legacy non-AI/ML measurement operation to be performed by the UE during the measurement time period, the measurement configuration further comprises an order of the AI/ML measurement operation and the legacy non-AI/ML measurement operation and an opportunistic flag enabling the UE to opportunistically complete the AI/ML measurement operation and the legacy non-AI/ML measurement operation.
Aspect 33: The method of any of aspects 20 through 24, 31, or 32, wherein the measurement time period comprises a processing timeline.
Aspect 34: An apparatus comprising a memory and a processor coupled to the memory, wherein the processor is configured to perform a method of any of aspects 1 through 19 or 20 through 33.
Aspect 35: An apparatus comprising means for performing a method of any of aspects 1 through 19 or 20 through 33.
Aspect 36: A non-transitory computer-readable medium having stored therein instructions configured to cause one or more processors of an apparatus to perform a method of any of aspects 1 through 19 or 20 through 33.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4-6, 10, 11, 13, 14, and/or 16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A user equipment (UE), comprising:
a transceiver configured to communicate with a network entity;
a memory; and
a processor coupled to the transceiver and the memory, the processor being configured to:
transmit a measurement capability of the UE to the network entity via the transceiver, the measurement capability indicating at least an artificial intelligence and machine learning (AI/ML) measurement capability of the UE; and
receive a measurement configuration from the network entity via the transceiver, the measurement configuration indicating a measurement time period within which the UE can perform at least an AI/ML measurement operation.

2. The UE of claim 1, wherein the measurement capability comprises a joint measurement capability indicating the AI/ML measurement capability and a legacy non-AI/ML measurement capability.

3. The UE of claim 2, wherein the joint measurement capability further indicates whether the UE supports a joint measurement operation including the AI/ML measurement operation and a corresponding legacy non-AI/ML measurement operation, the joint measurement capability further indicating whether the UE supports in parallel processing of the AI/ML measurement operation and the legacy non-AI/ML measurement operation or sequential processing of the AI/ML measurement operation and the legacy non-AI/ML measurement operation.

4. The UE of claim 3, wherein the joint measurement capability further indicates the measurement time period for performing the joint measurement operation in parallel or sequentially.

5. The UE of claim 1, wherein the measurement capability is specific to the AI/ML measurement operation or a joint measurement operation including the AI/ML measurement operation and a corresponding legacy non-AI/ML measurement operation.

6. The UE of claim 1, wherein the measurement time period comprises a measurement gap.

7. The UE of claim 6, wherein the measurement gap comprises a measurement gap length corresponding to one of a plurality of legacy non-AI/ML measurement gap lengths.

8. The UE of claim 6, wherein the measurement gap comprises an AI/ML measurement gap having an AI/ML measurement gap length selected from a plurality of AI/ML measurement gap lengths different than a plurality of legacy non-AI/ML measurement gap lengths.

9. The UE of claim 8, wherein the measurement configuration further comprises a legacy non-AI/ML measurement gap within which the UE can perform a legacy non-AI/ML measurement operation, the legacy non-AI/ML measurement gap having one of the plurality of legacy non-AI/ML measurement gap lengths.

10. The UE of claim 6, wherein the measurement gap comprising a measurement gap length equal to a sum of an offset value and one of a plurality of legacy non-AI/ML measurement gap lengths.

11. The UE of claim 10, wherein the offset value is selected from a set of offset values.

12. The UE of claim 10, wherein the offset value is based on the measurement capability of the UE.

13. The UE of claim 10, wherein the measurement configuration further comprises a legacy non-AI/ML measurement gap within which the UE can perform a legacy non-AI/ML measurement operation, the legacy non-AI/ML measurement gap having one of the plurality of legacy non-AI/ML measurement gap lengths.

14. The UE of claim 1, wherein the measurement configuration is associated with an AI/ML model monitoring operation including both the AI/ML measurement operation and a corresponding legacy non-AI/ML measurement operation, and the measurement time period is configured to enable the UE to perform both the legacy non-AI/ML measurement operation and the AI/ML measurement operation.

15. The UE of claim 1, wherein the measurement configuration is associated with a joint measurement operation including the AI/ML measurement operation and a legacy non-AI/ML measurement operation to be performed by the UE during the measurement time period, the measurement configuration further comprises an order of the AI/ML measurement operation and the legacy non-AI/ML measurement operation and an opportunistic flag enabling the UE to opportunistically complete the AI/ML measurement operation and the legacy non-AI/ML measurement operation.

16. The UE of claim 15, wherein the opportunistic flag enables the UE to opportunistically perform the AI/ML measurement operation and the legacy non-AI/ML measurement operation in a different order than the order included within the measurement configuration.

17. The UE of claim 15, wherein the opportunistic flag enables the UE to opportunistically extend the measurement time period to complete the AI/ML measurement operation and the legacy non-AI/ML measurement operation.

18. The UE of claim 15, wherein the processor is further configured to:
perform the AI/ML measurement operation and the legacy non-AI/ML measurement operation based on the opportunistic flag; and
transmit a measurement report to the network entity.

19. The UE of claim 1, wherein the measurement time period comprises a processing timeline.

20. A method for wireless communication at a user equipment (UE), the method comprising:
transmitting a measurement capability of the UE to a network entity, the measurement capability indicating at least an artificial intelligence and machine learning (AI/ML) measurement capability of the UE; and
receiving a measurement configuration from the network entity, the measurement configuration indicating a measurement time period within which the UE can perform at least an AI/ML measurement operation.

21. The method of claim 20, wherein the measurement capability comprises a joint measurement capability indicating the AI/ML measurement capability and a legacy non-AI/ML measurement capability.

22. A network entity, comprising:
a memory; and
a processor coupled to the memory, the processor configured to:
receive a measurement capability of a user equipment (UE), the measurement capability indicating at least an artificial intelligence and machine learning (AI/ML) measurement capability of the UE; and
provide a measurement configuration for the UE, the measurement configuration indicating a measurement time period within which the UE can perform at least an AI/ML measurement operation.

23. The network entity of claim 22, wherein the measurement capability comprises a joint measurement capability indicating the AI/ML measurement capability and a legacy non-AI/ML measurement capability.

24. The network entity of claim 23, wherein:
the joint measurement capability further indicates whether the UE supports a joint measurement operation including the AI/ML measurement operation and a corresponding legacy non-AI/ML measurement operation,
the joint measurement capability further indicates whether the UE supports in parallel processing of the AI/ML measurement operation and the legacy non-AI/ML measurement operation or sequential processing of the AI/ML measurement operation and the legacy non-AI/ML measurement operation, and
the joint measurement capability further indicates the measurement time period for performing the joint measurement operation in parallel or sequentially.

25. The network entity of claim 22, wherein the measurement time period comprises a measurement gap or a processing timeline.

26. The network entity of claim 25, wherein the measurement gap comprises a measurement gap length corresponding to one of a plurality of legacy non-AI/ML measurement gap lengths or equal to a sum of an offset value and one of the plurality of legacy non-AI/ML measurement gap lengths.

27. The network entity of claim 26, wherein the processor is further configured to:
select the offset value from a set of offset values.

28. The network entity of claim 25, wherein the measurement gap comprises an AI/ML measurement gap having an AI/ML measurement gap length selected from a plurality of AI/ML measurement gap lengths different than a plurality of legacy non-AI/ML measurement gap lengths.

29. The network entity of claim 20, wherein the measurement configuration is associated with a joint measurement operation including the AI/ML measurement operation and a legacy non-AI/ML measurement operation to be performed by the UE during the measurement time period, the measurement configuration further comprises an order of the AI/ML measurement operation and the legacy non-AI/ML measurement operation and an opportunistic flag enabling the UE to opportunistically complete the AI/ML measurement operation and the legacy non-AI/ML measurement operation.

30. A method for wireless communication at a network entity, comprising:
receiving a measurement capability of a user equipment (UE), the measurement capability indicating at least an artificial intelligence and machine learning (AI/ML) measurement capability of the UE; and
providing a measurement configuration for the UE, the measurement configuration indicating a measurement time period within which the UE can perform at least an AI/ML measurement operation.
